(19) United States
(12) Patent Application Publication
(10) Pub. No.: US 2017/0262494 A1
(43) Pub. Date: Sep. 14, 2017

(54) COMMUNICATION DEVICE, LOG INFORMATION MANAGEMENT METHOD AND COMPUTER-READABLE RECORDING MEDIUM

(71) Applicant: Akira Masuda, Tokyo (JP)

(72) Inventor: Akira Masuda, Tokyo (JP)

(73) Assignee: Ricoh Company, Ltd., Tokyo (JP)

(21) Appl. No.: 15/452,559

(22) Filed: Mar. 7, 2017

(30) Foreign Application Priority Data
Mar. 14, 2016 (JP) 2016049542

(51) Int. Cl. G06F 17/30

(52) U.S. Cl. CPC G06F 17/30377; G06F 17/30424; H04W 88/02

(57) ABSTRACT

A communication device includes circuitry configured to acquire, from other device, deletion check information for checking whether log information in an own device containing a log on connections with other devices contains delible information; determine whether the log information in the own device contains delible information based on the acquired deletion check information; and delete, when it is determined that delible information is contained in the log information in the own device, corresponding information from the log information in the own device.

### CROSS-REFERENCE TO RELATED APPLICATIONS

The present application claims priority under 35 U.S.C. §119 to Japanese Patent Application No. 2016-049542, filed Mar. 14, 2016. The contents of which are incorporated herein by reference in their entirety.

### BACKGROUND OF THE INVENTION

1. Field of the Invention

The present invention relates to a communication device, a log information management method and a computer-readable recording medium having a log information management program.

2. Description of the Related Art

A technology has been known conventionally where devices connected via a network hold log information on connections with devices with each of which a connection was established once and use the log information to re-connect to a device with which a connection was made once. In recent years, there have been a wireless communication standard referred to as Wi-Fi Direct (trademark) for making wireless communications by connecting devices having a wireless LAN function without any access point and without requiring users to make complicated settings. Wi-Fi Direct uses a log connection function that simplifies the connection process by using the connection log to re-connect to a device to which a connection was made once.

### SUMMARY OF THE INVENTION

According to exemplary embodiments of the present invention, there is provided a communication device comprising circuitry configured to acquire, from other device, deletion check information for checking whether log information in an own device containing a log on connections with other devices contains delible information; determine whether the log information in the own device contains delible information based on the acquired deletion check information; and delete, when it is determined that delible information is contained in the log information in the own device, corresponding information from the log information in the own device.

Exemplary embodiments of the present invention also provide a log information management method executed by a communication device, the method comprising: acquiring, from other device, deletion check information for checking whether log information in an own device containing a log on connections with other devices contains delible information; determining whether the log information in the own device contains delible information based on the acquired deletion check information; and when it is determined that delible information is contained in the log information in the own device, deleting corresponding information from the log information in the own device.

Exemplary embodiments of the present invention also provide a non-transitory computer-readable recording medium that contains a log information management program that causes a communication device to execute a process comprising: acquiring, from other device, deletion check information for checking whether log information in an own device containing a log on connections with other devices contains delible information; determining whether the log information in the own device contains delible information based on the acquired deletion check information; and when it is determined that delible information is contained in the log information in the own device, deleting corresponding information from the log information in the own device.

### BRIEF DESCRIPTION OF THE DRAWINGS

FIG. 1 is a diagram illustrating an exemplary wireless communication standard used in an embodiment;

FIG. 2A is a diagram illustrating an exemplary connection process according to the wireless communication standard used in the embodiment;

FIG. 2B is a diagram illustrating the exemplary connection process according to the wireless communication standard used in the embodiment;

FIG. 2C is a diagram illustrating the exemplary connection process according to the wireless communication standard used in the embodiment;

FIG. 2D is a diagram illustrating the exemplary connection process according to the wireless communication standard used in the embodiment;

FIG. 2E is a diagram illustrating the exemplary connection process according to the wireless communication standard used in the embodiment;

FIG. 2F is a diagram illustrating the exemplary connection process according to the wireless communication standard used in the embodiment;

FIG. 3A is a diagram illustrating an exemplary log connection process according to the wireless communication standard used in the embodiment;

FIG. 3B is a diagram illustrating an exemplary log connection process according to the wireless communication standard used in the embodiment;

FIG. 3C is a diagram illustrating an exemplary log connection process according to the wireless communication standard used in the embodiment;

FIG. 3D is a diagram illustrating an exemplary log connection process according to the wireless communication standard used in the embodiment;

FIG. 3E is a diagram illustrating an exemplary log connection process according to the wireless communication standard used in the embodiment;

FIG. 4A is a diagram illustrating an exemplary unnecessary log that is generated from a log connection according to the wireless communication standard used in the embodiment;

FIG. 4B is a diagram illustrating the exemplary unnecessary log that is generated from the log connection according to the wireless communication standard used in the embodiment;

FIG. 4c is a diagram illustrating the exemplary unnecessary log that is generated from the log connection according to the wireless communication standard used in the embodiment;

FIG. 5 is a diagram of an exemplary system configuration of a log information management system according to a first embodiment;

FIG. 6 is a block diagram of an exemplary hardware configuration of a communication device according to the first embodiment;

FIG. 7 is a block diagram of an exemplary functional configuration according to the first embodiment;

FIG. 8A is a diagram illustrating exemplary deletion of an unnecessary log in a search phase according to the first embodiment;

FIG. 8B is a diagram illustrating the exemplary deletion of an unnecessary log in a search phase according to the first embodiment;

FIG. 8C is a diagram illustrating the exemplary deletion of an unnecessary log in a search phase according to the first embodiment;

FIG. 8D is a diagram illustrating the exemplary deletion of an unnecessary log in a search phase according to the first embodiment;

FIG. 9A is a diagram illustrating exemplary deletion of an unnecessary log in a search phase according to the first embodiment;

FIG. 9B is a diagram illustrating the exemplary deletion of an unnecessary log in a search phase according to the first embodiment;

FIG. 9C is a diagram illustrating the exemplary deletion of an unnecessary log in a search phase according to the first embodiment;

FIG. 9D is a diagram illustrating the exemplary deletion of an unnecessary log in a search phase according to the first embodiment;

FIG. 9E is a diagram illustrating the exemplary deletion of an unnecessary log in a search phase according to the first embodiment;

FIG. 10 is a sequence chart of an exemplary flow of a log deletion process performed between communication devices according to the first embodiment;

FIG. 11 is a flowchart of an exemplary flow of a log deletion determining process according to the first embodiment;

FIG. 12 is a block diagram of an exemplary functional configuration of a communication device according to a second embodiment;

FIG. 13 is a flowchart of an exemplary flow of a log deletion determining process according to the second embodiment;

FIG. 14 is a block diagram of an exemplary functional configuration of a communication device according to a third embodiment;

FIG. 15 is a flowchart of an exemplary flow of a log deletion determining process according to the third embodiment;

FIG. 16 is a block diagram of an exemplary functional configuration of a communication device according to a fourth embodiment; and

FIG. 17 is a flowchart of an exemplary flow of a log deletion determining process according to the fourth embodiment.

The accompanying drawings are intended to depict exemplary embodiments of the present invention and should not be interpreted to limit the scope thereof. Identical or similar reference numerals designate identical or similar components throughout the various drawings.

### DESCRIPTION ACCORDING TO THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of the communication device, the log information management method and the computer-readable recording medium having the log information management program according to the present invention will be described with reference to the accompanying drawings. The following embodiments do not limit the invention. The embodiments may be combined as appropriate within a range where no discrepancy is caused.

### FIRST EMBODIMENT

### Communication Standard

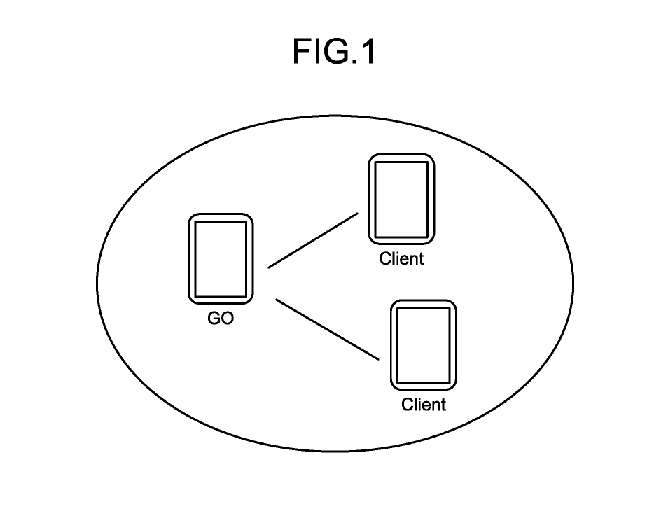

The wireless communication standard used in an embodiment will be described below with reference to FIG. 1. FIG. 1 is a diagram illustrating an exemplary wireless communication standard used in the embodiment.

In the embodiment, Wi-Fi Direct (trademark) is used as a mode of a wireless communication standard. Wi-Fi Direct is a standard for wireless devices to make a peer-to-peer connection not via any access point as illustrated in FIG. 1. Each of the devices connected according to Wi-Fi Direct has any one of roles referred to as a Client and a group owner (GO). A Client corresponds to a station of a normal wireless connection. A GO has the same role as that of an access point of a normal wireless connection. At least one Client is connectable to one GO and the connection made by one or more Clients and one GO is referred to as a group.

### Connection Process according to Wireless Communication Standard

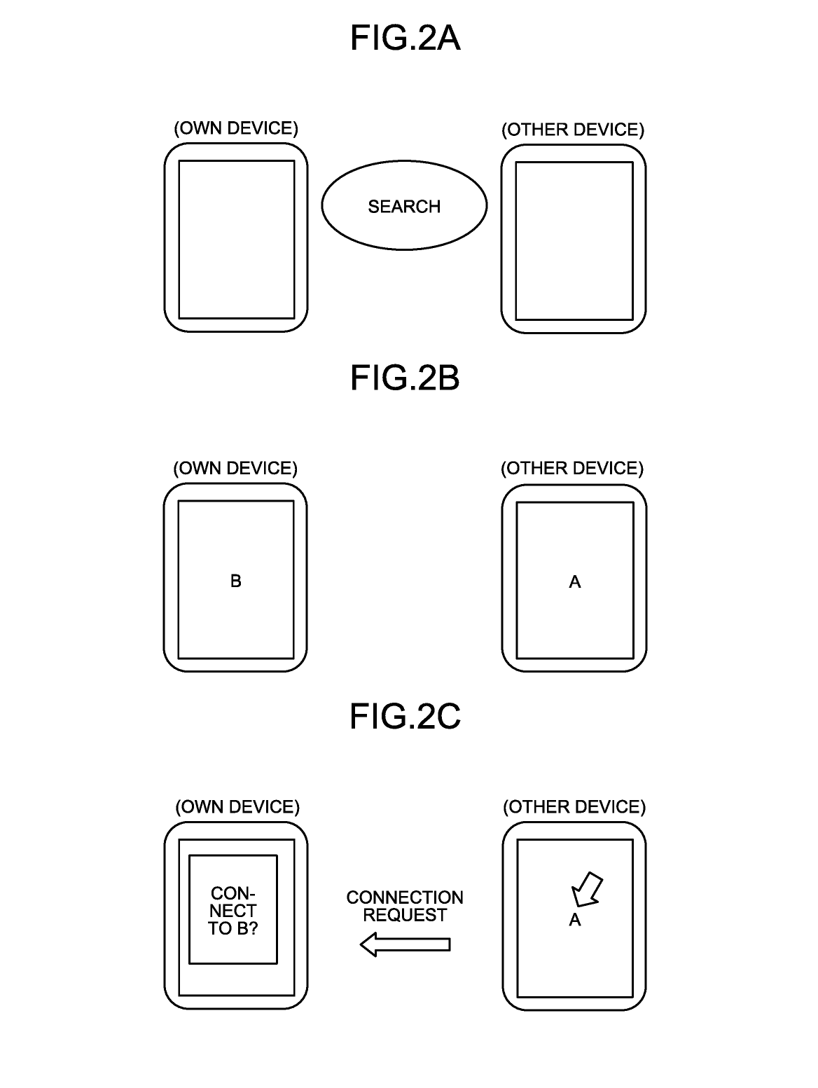

A connection process according to the wireless communication standard used in the embodiment will be described with reference to FIGS. 2A to 2F. FIGS. 2A to 2F are diagrams illustrating an exemplary connection process according to the wireless communication standard used in the embodiment.

As illustrated in FIG. 2A, once Wi-Fi Direct starts, both an own device (a device owned by a user) and an other device that are wireless devices output search packets to search for surrounding wireless devices. As illustrated in FIG. 2B, each of the wireless devices displays information on the wireless device that is found by the search. Assume that, in the example illustrated in FIG. 2B, the own device is a wireless device A and the other device is a wireless device B. The screen of the own device displays that the wireless device B has been found and the screen of the other device displays that the wireless device A has been found. As illustrated in FIG. 2C, the wireless device B outputs a packet for a connection request to the wireless device A in response to an operation of a user to choose the wireless device A on the screen. Accordingly, a check screen for permitting a connection to the wireless device B is displayed on the screen of the wireless device A having received the packet for the connection request.

As illustrated in FIG. 2D, the user who carries the wireless device A performs an operation to permit a connection to the wireless device B. Once the connection is permitted, as illustrated in FIG. 2E, a connection process is performed between the wireless device A and the wireless device B. In the connection process, packets used for the connection are communicated for multiple times. For example, in the connection process, Group Owner Negotiation, WPS (trademark) and a WPA2 (trademark) authentication process are performed. Group Owner Negotiation is communications for determining which one of the wireless devices serves as a GO. WPS is a process for safely passing information used for wireless connection. In the WPA2 authentication process, final connection authentication is performed by using the information used for wireless connection that is acquired by WPS. Accordingly, as illustrated in FIG. 2F, which wireless device servers as the GO is determined and which wireless device serves as the Client is determined, a connection between the wireless devices is established, and a group is formed. In the example illustrated in FIG. 2F, the wireless device A that is the own device serves as a GO, and the wireless device B that is the other device serves as a Client, and a group “Group 1” including the wireless device A as the GO is formed. Information on Group 1 is registered in the log.

In each of the wireless devices, a group log is recorded. The information recorded in the log more or less differs between the GO and the Client. The following is exemplary information to be recorded in the log.
GO side
Credential information (information used for wireless connection to be communicated according to WPS)
SSID Example: DIRECT-dx-printerA
Pass phrase Example: dj3289s1j
Authentication system Example: WPA2-PSK
Encryption system Example: CCMP
Wireless addresses of group members
Example: 5e: f5: gr: 33: d4: e5: de: 45: gh: i6: tg: 33
Group ID
Example: DIRECT-dx-printerA df: fe: t4: 5t: 34: rr
Client side
Credential information
Wireless address of GO
Group ID
Log Connection according to Wireless Communication Standard

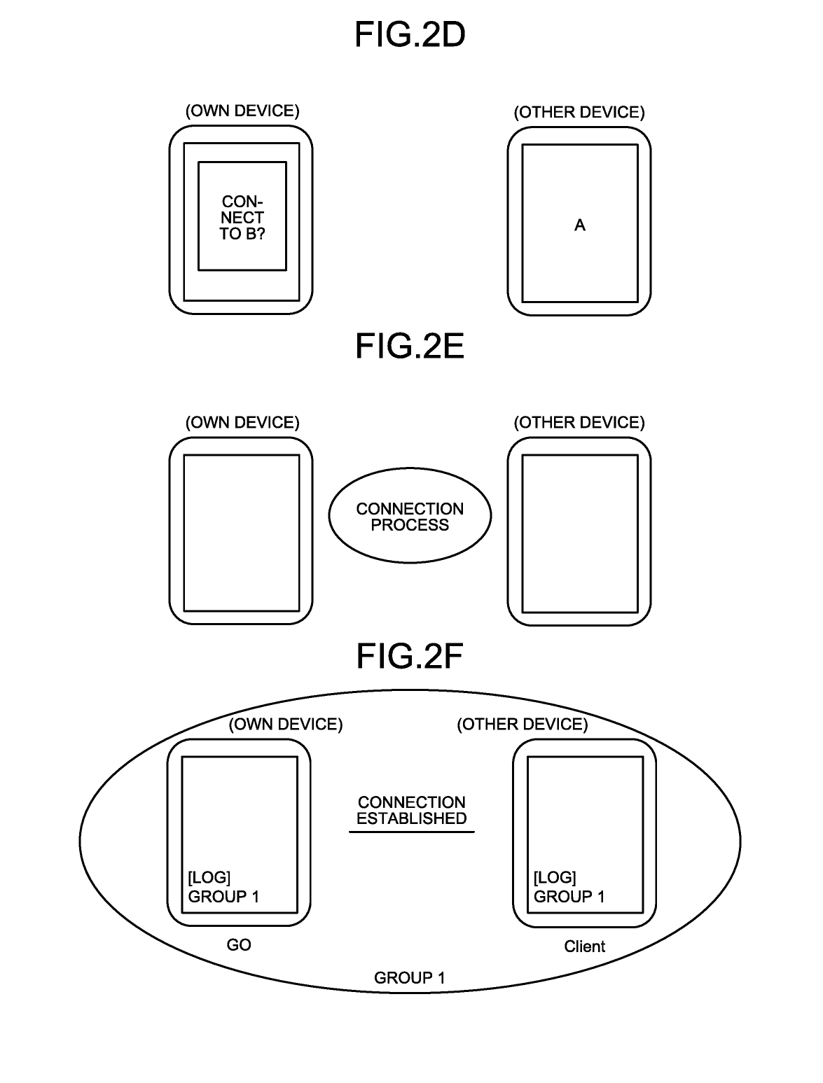

With reference to FIGS. 3A to 3E, the log connection process according to the wireless communication standard used in the embodiment will be described here. FIGS. 3A to 3E are diagrams illustrating an exemplary log connection process according to the wireless communication standard used in the embodiment.

After the GO and the Client are disconnected and the group is disbanded, as illustrated in FIG. 3A, the wireless devices search for surrounding wireless devices (the same as the step illustrated in FIG. 2A). As illustrated in FIG. 3B, each of the wireless devices displays information on a found wireless device (the same as the step illustrated FIG. 2B). As illustrated in FIG. 3C, the wireless device B checks whether the log for a connection to the wireless device A is registered in response to an operation of a user to choose the wireless device A on the screen. The wireless device A is the GO in Group 1 that is registered in the log and it is possible to make a connection using the log, and the wireless device B therefore outputs a request for a connection using the log.

As illustrated in FIG. 3D, the wireless device A and the wireless device B perform a connection process for re-forming Group 1 based on the information registered in the log. In the example illustrated in FIG. 3D, re-formation of the group using the log is referred to as a “simple connection process”. For example, the information used for connection (credential) is already stored as the log and therefore the processes, such as the Group Owner Negotiation and WPS, are omitted and the WPA2 authentication process is performed. The operation of the user to permit a connection is not performed either. Accordingly, as illustrated in FIG. 3E, Group 1 including the wireless device A and the wireless device B is formed again and a connection is established. Compared to a connection not using the log, there is a significant omission in the user operations and the connection process and accordingly it is possible to reduce the time for operations and shorten the time for the connection process.

### Unnecessary Log

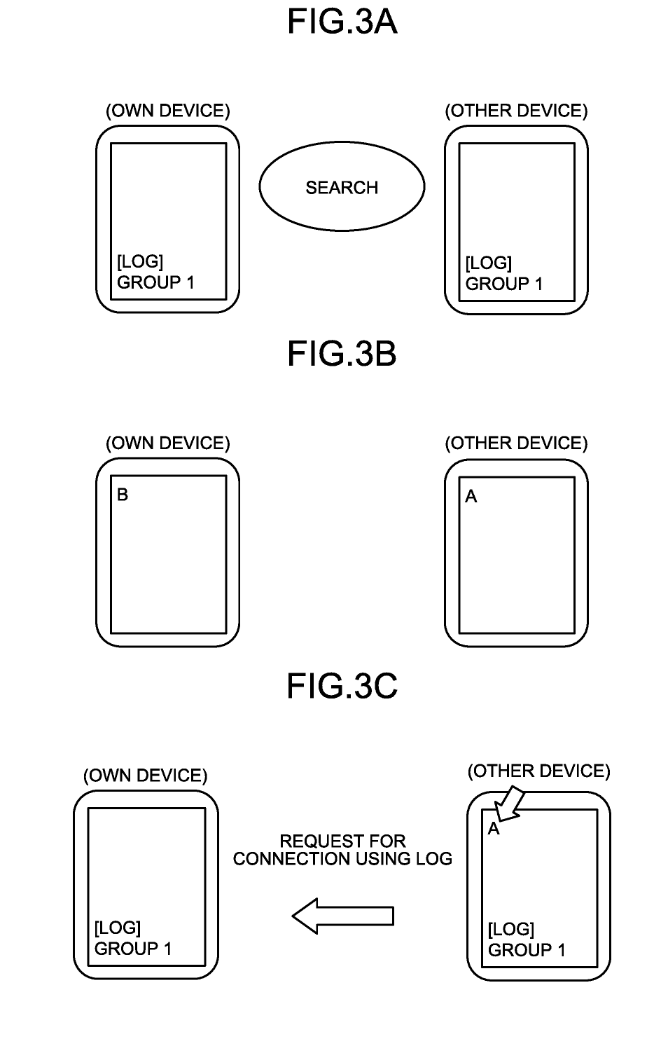

With reference to FIGS. 4A to 4C, an unnecessary log that is generated from a log connection according to the wireless communication standard used in the embodiment will be described. FIGS. 4A to 4C are diagrams illustrating an exemplary unnecessary log that is generated from a log connection according to the wireless communication standard used in the embodiment.

In general, an upper limit is set for the number of registrable logs. The log is left even when the power of the wireless device is turned off and thus is saved in a non-volatile area. For this reason, when the Wi-Fi Direct function is started, a process of reading the log from non-volatile area is performed. An increase in the number of logs increases the time to start the Wi-Fi Direct function.

The usable RAM capacity is limited and thus an upper limit is set. For example, when the upper limit is reached, logs are deleted from an old log. Accordingly, it is not possible to make a re-connection using the deleted log. When logs are deleted from an old log, an unnecessary log may occur (remain) as described below.

As illustrated in FIG. 4A, in a state where a log on Group 1 is registered in the wireless device A and the wireless device B, the log on Group 1 is deleted (for example, it is deleted by a user operation) on the wireless device B. This leads to a state where the log on Group 1 is registered only in the wireless device A and is not registered in the wireless device B. It is not possible to make a re-connection using the log unless the log is registered in both the wireless devices. In other words, the log on Group 1 in the wireless device A is information not to be used.

As illustrated in FIG. 4B, the wireless device B does not store the log on Group 1 and thus performs a normal connection process without using the log. As illustrated in FIG. 4C, once a connection is established by performing the normal connection process, information indicating a new group “Group 2” is registered in the logs in the wireless device A and the wireless device B. As described above, the log on Group 1 in the wireless device A is the unnecessary log not to be used. As described above, there is a possibility that an unnecessary and unsynchronized log would remain in any one of the wireless devices. When the wireless device A tries to re-connect to the wireless device B by using the log on Group 1 in the state illustrated in FIG. 4B, the wireless device B having received a log connection request outputs a response indicating that it is not possible to make a connection using the log. For this reason, the wireless device A performs the normal connection process. Each of embodiments to solve these problems will be described below.

### System Configuration according to First Embodiment

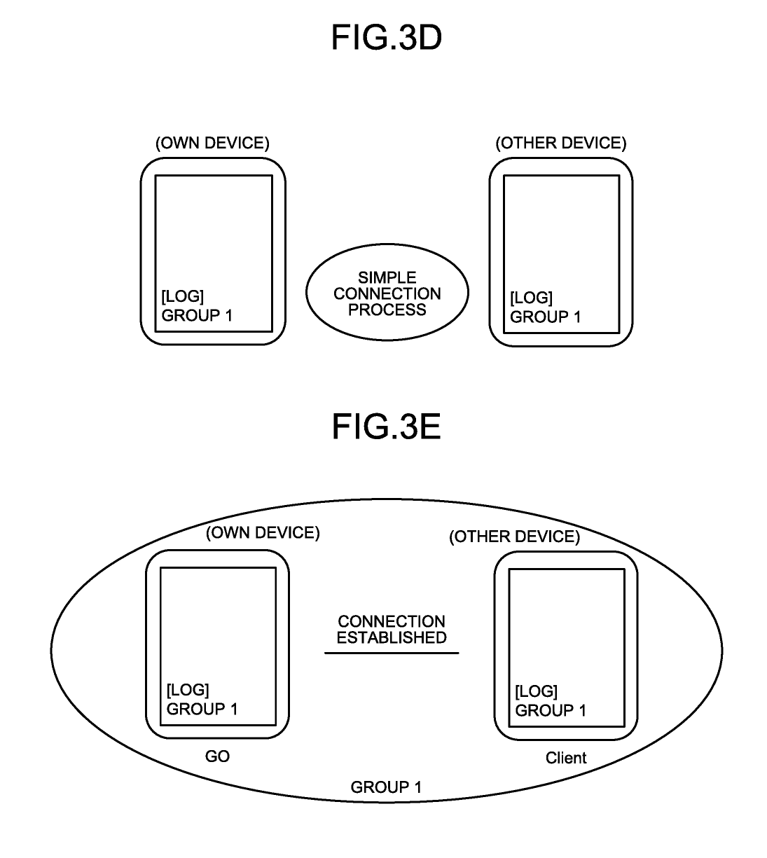

With reference to FIG. 5, a system configuration of a log information management system 1 according to the first embodiment will be described. FIG. 5 is a diagram of an exemplary system configuration of the log information management system 1 according to the first embodiment.

As illustrated in FIG. 5, the log information management system 1 includes multiple communication devices 100. In the log information management system 1, at least one Client is connected to one GO. FIG. 5 illustrates an example where two communication devices 100 that are Clients are connected to the communication device 100 that is a GO.

### Hardware Configuration of Communication Device according to First Embodiment

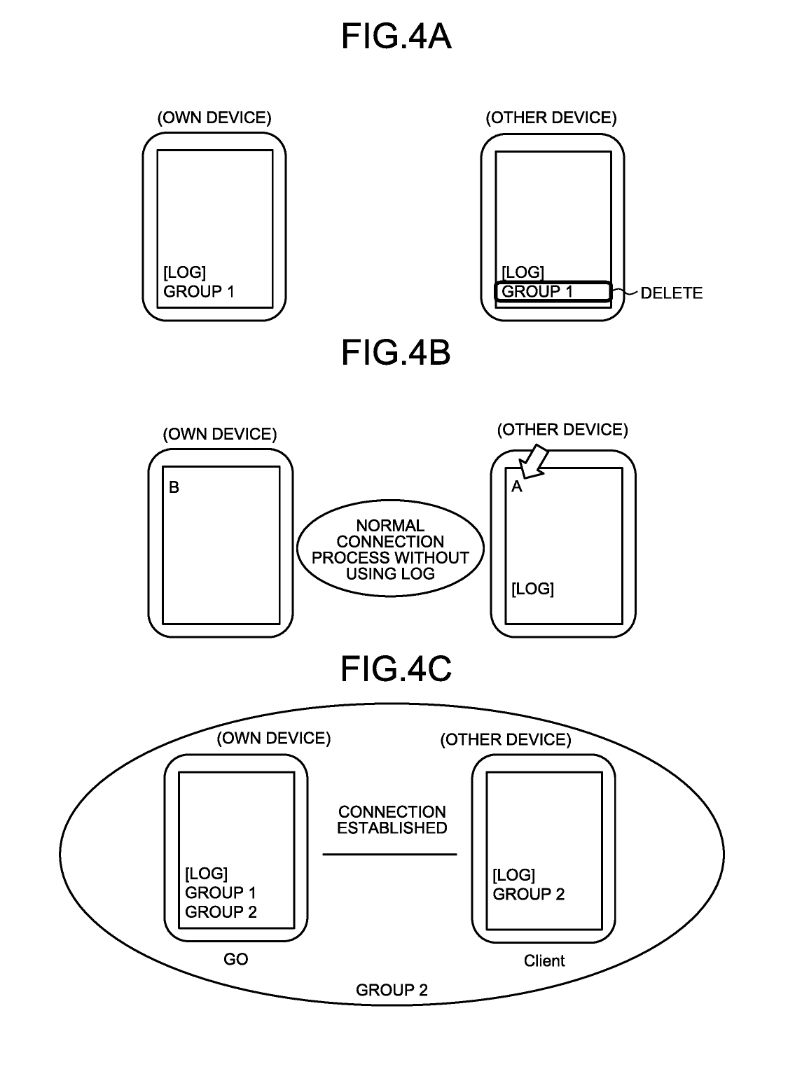

With reference to FIG. 6, a hardware configuration of the communication device 100 according to the first embodiment will be described here. FIG. 6 is a block diagram of an exemplary hardware configuration of the communication device 100 according to the first embodiment.

As illustrated in FIG. 6, the communication device 100 includes a CPU 12, a RAM 13, a ROM 14, a communication unit 15 and a display operation unit 16. These components are connected with one another via a bus 11.

The CPU 12 controls entire operations of the communication device 100. The CPU 12 uses, for example, the RAM 13 as a work area an executes a program that is stored in, for example, the ROM 14 to control the entire operations of the communication device 100. The ROM 14 stores the program for implementing the processes performed by the communication device 100. The RAM 13 is the work area used to execute the program that is stored in, for example, the ROM 14. The communication unit 15 is an interface for communicating with external devices, such as the other devices (other communication devices 100). The display operation unit 16 is an interface for controlling operation inputs and display outputs according to the control of the CPU 12.

### Functional Configuration of Communication Device according to First Embodiment

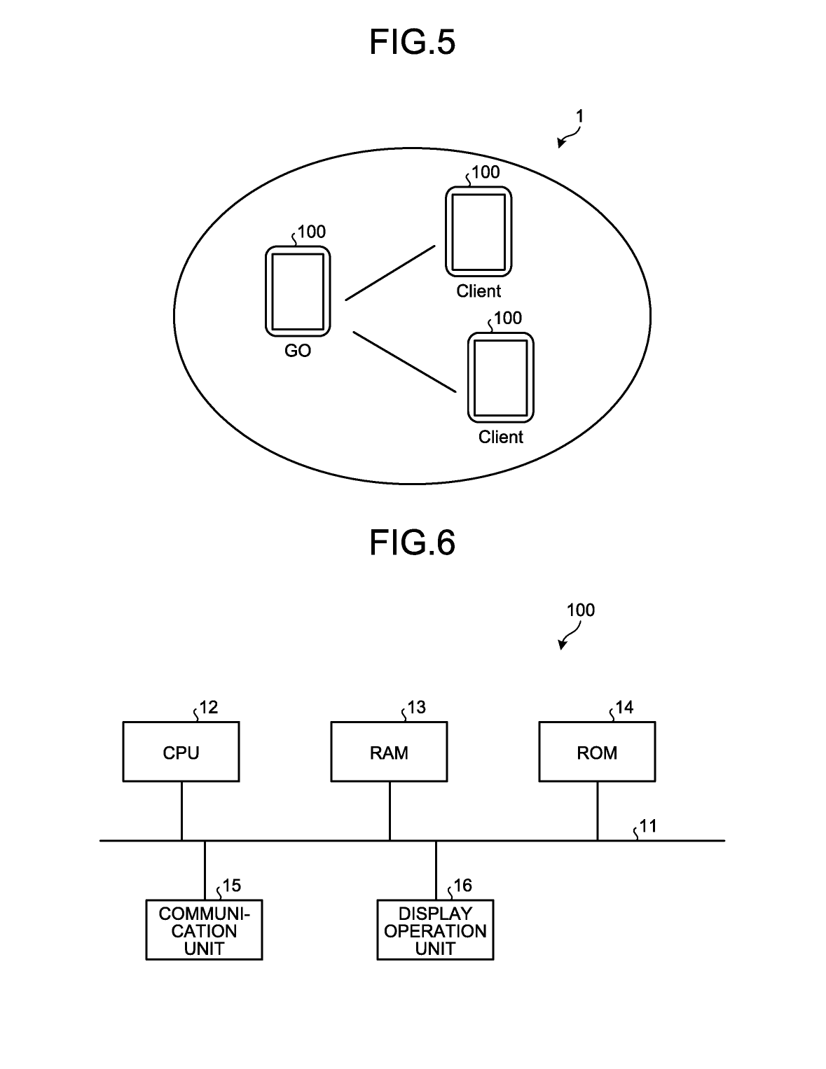

With reference to FIG. 7, a functional configuration of the communication device 100 according to the first embodiment will be described. FIG. 7 is a block diagram of an exemplary functional configuration of the communication device 100 according to the first embodiment.

As illustrated in FIG. 7, the communication device 100 includes a communication controller 110, an acquisition unit 120, a determining unit 130 and a log deletion unit 140. All or part of the components may be implemented by using software (a program) or may be implemented by using a hardware circuit.

The communication controller 110 controls communications with the other devices. More specifically, the communication controller 110 controls the communication unit 15 and communicates various types of information with other communication devise 100 via the communication unit 15. For example, the communication controller 110 communicates search packets according to Wi-Fi Direct and various types of information used for, for example, the connection process with other communication devices 100.

The acquisition unit 120 acquires, from the other device, deletion check information for checking whether the log information of the own device contains delible information. More specifically, the acquisition unit 120 acquires, from the other device, deletion check information containing the group ID stored in the other device and the device address information of the other device. The deletion check information is acquired on transmission and reception of search messages. In other words, the acquisition unit 120 acquires the deletion check information from the other device on transmission and reception of the search packets for searching for a connectable other device under the control of the communication controller 110. The log information contains the group ID for identifying the group consisting of at least two of the communication devices 100 between which a connection is established and device address information indicating the address of the other device contained in the group. The acquisition unit 120 acquires deletion check information that is used to check whether the log information in the other device and the log information in the own device are synchronized with each other. The deletion check information is acquired not by using a dedicated packet but on transmission and reception of the search packets and thus it is unnecessary to prepare a new packet or use a line for checking.

The determining unit 130 determines whether the log information in the own device contains delible information. More specially, the determining unit 130 determines whether a combination of the group ID stored in the other device and the device address information of the other device is contained in the log information in the own device.

When it is determined that the log information in the own device contains delible information, the log deletion unit 140 deletes corresponding information from the log information in the own device. More specifically, when the determining unit 130 determines that the combination of the group ID stored in the other device and the device address information of the other device is not contained in the log information in the own device, the log deletion unit 140 deletes information on a group that is stored only in the own device from the log information in the own device. In other words, when a log on a corresponding group is not in the log information in the peer communication device 100 that is contained in the group in the log information stored in the own device, the log deletion unit 140 deletes the corresponding information from the log information in the own device.

When the determining unit 130 determines that the combination of the group ID stored in the other device and the device address information of the other device is not contained in the log information in the own device, the log deletion unit 140 adds determination information to (sets a flag in) the device address information of the other device that is contained in the information on the group that is stored only in the own device. When the determination information is added to (a flag is set in) all sets of device address information of the other devices contained in the information on the group, the log deletion unit 140 deletes the information on the group that is stored only in the own device from the log information in the own device. In other words, when the log of the corresponding group is not in all sets of log information in other communication devices 100 contained in the group in the log information stored in the own device, the log deletion unit 140 deletes the corresponding information from the log information in the own device.

### Deletion of Unnecessary Log in Search Phase

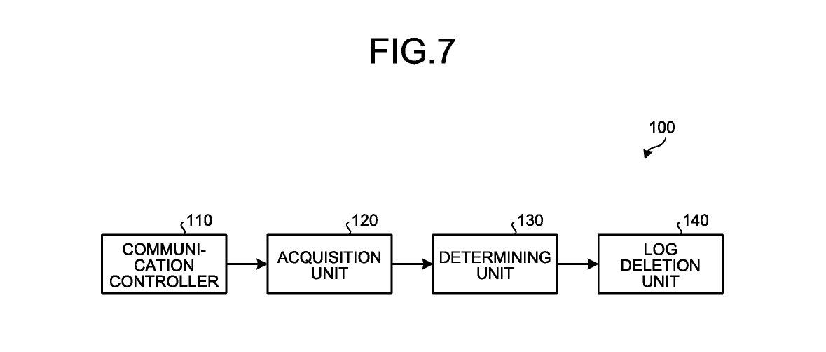

With reference to FIGS. 8A to 8D, deletion of an unnecessary log in a search phase according to the first embodiment will be described here. FIGS. 8A to 8D are diagrams illustrating exemplary deletion of an unnecessary log in the search phase according to the first embodiment. FIGS. 8A to 8D exemplifies deletion of an unnecessary log between one own device (GO) and one other device (Client).

As illustrated in FIG. 8A, in the search phase of Wi-Fi Direct, search packets referred to as a probe request and a probe response are communicated in order to search for surrounding devices compatible with Wi-Fi-Direct. The probe request is a packet for searching for a counter device according to Wi-Fi Direct and is transmitted by broadcasting. The probe response is a packet of a response to the probe request and that contains information indicating that the device that receives the probe request is the counter device and contains Wi-Fi Direct specification information on the device. The probe response is transmitted as a response only to the device that is the transmitter of the probe request is transmitted. In the search phase, the probe request and the probe response are communicated and accordingly the devices are found with each other. Even when a peer is found once, communications of the probe request and the probe response do not end and are repeated in the search phase (see FIG. 8A(1) and FIG. 8A(2)).

Deletion of an unnecessary log will be described here by using exemplary log information in an own device and exemplary log information in other device, where the own device is a communication device A and the other device is a communication device B. The other devices different from the communication device B are a communication device C and a communication device E.

Log of communication device A (own device)
Group 3 CL:B
Group 2 GO:C
Group 1 GO:B
   Log of communication device B (other device)
Group 3 GO:A, E
Group 1 CL:A

For example, in the above-described log in the own device, Group 3 is log information on a group in which the communication device A serving as a Client and the communication device B serving as a GO are connected with each other. In the above-described log in the own device, Group 2 is log information on a group in which the communication device A serving as a GO and the communication device C serving as a Client are connected with each other. In the above-described log of the own device, Group 1 is log information on a group in which the communication device A serving as a GO and the communication device B serving as a Client are connected with each other. When the own device is a Client, information on other Clients is not used for re-connection using the log and thus is not stored. In other words, when the own device is a Client, only information on the device serving as a GO is registered in the log. On the other hand, when the own device is a GO, information on the device(s) serving as a Client(s) is registered in the log.

For example, in the above-described log in the above-described other device, Group 3 is log information on a group in which the communication device B serving as a GO, the communication device A serving as a Client, and the communication device E serving as a Client are connected with one another. Group 3 that is contained in the log in the other device is the same group as that in the log on Group 3 stored by the communication device A that is the own device. In the log in the other device, Group 1 is log information on a group in which the communication device B serving as a Client and the communication device A serving as a GO are connected with each another. Group 1 that is contained in the log in the other device is the same group as that in the log on Group 1 stored in the communication device A that is the own device.

As illustrated in FIG. 8B, the log information on Group 1 in the other device is deleted by a user operation. At this point, the other device stores only the log information on Group 3. Both the own device and the other device then enter the search phase. As illustrated in FIG. 8C, the own device transmits a probe_req to the other device. The other device having received the probe_req checks whether the log containing the communication device A that is the transmitter is contained in the log information in the other device. When there is the log information containing the communication device A, the other device adds the group ID as deletion check information to the packet of a probe_resp and makes a response and, when there is not the log information containing the communication device A, the other device adds the group ID of Group 3 and the device address information of the other device as deletion check information to the packet of the probe_resp and makes a response.

As illustrated in FIG. 8D, when the received probe_resp contains the deletion check information, the own device checks the content of the deletion check information. As a result of the check, the own device recognizes that the log information on Group 3 is recorded and the log information on Group 1 is not recorded in the communication device B that is the other device. Only the communication device B is contained as a member in the log on Group 1 in the own device and the communication device B does not store the log on group 1 and thus the communication device A determines that the log on Group 1 is unnecessary and deletes the log on Group 1.

Accordingly, it is possible to synchronize the sets of log information stored in the devices. Furthermore, the probe_req and the probe_resp that are communicated normally in the search phase are used and thus it is unnecessary to communicate new packets to synchronize the sets of log information. The probe_req and the probe_resp are also communicated in the opposite direction (from the other device to the own device). Accordingly, the communication device A deletes the log information on Group 1 and, even when the log information on Group 1 remains in the communication device B, the log information on Group 1 in the communication device B is deleted. As described above, the probe_req and the probe_resp are communicated repeatedly in the search phase.

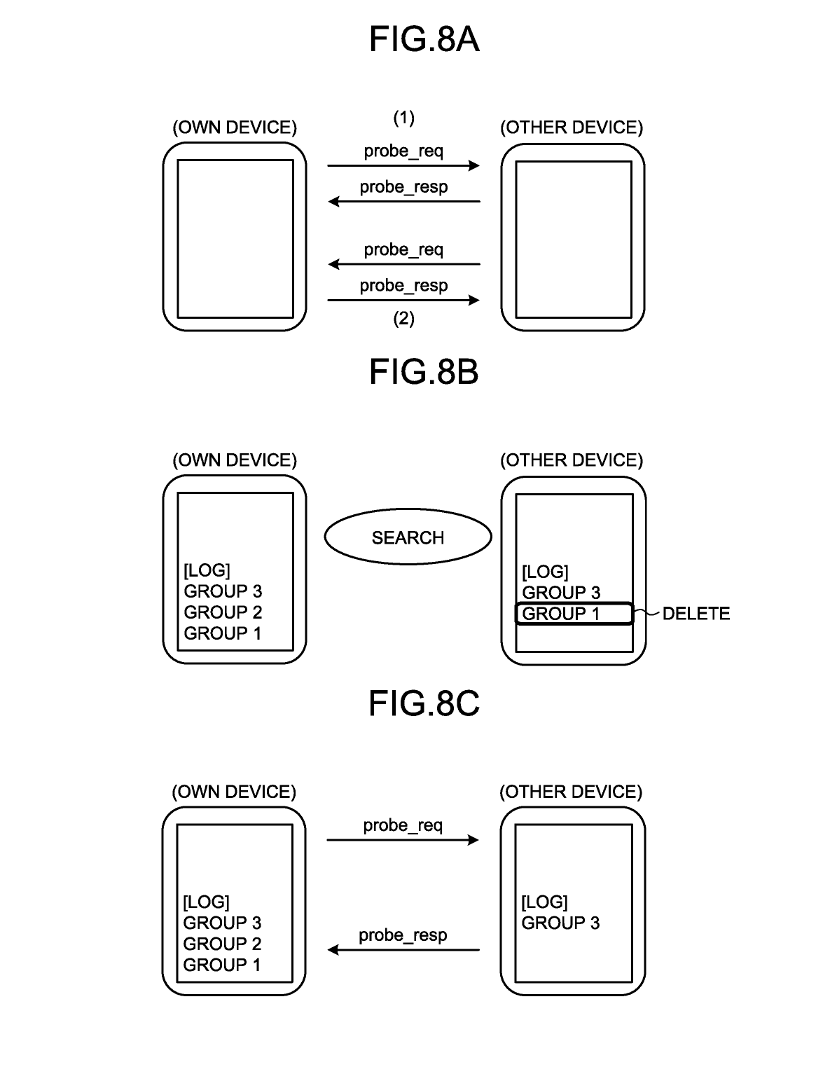

With reference to FIGS. 9A to 9E, deletion of an unnecessary log in the search phase according to the first embodiment will be described. FIGS. 9A to 9E are diagrams illustrating exemplary deletion of an unnecessary log in the search phase according to the first embodiment. FIGS. 9A to 9E exemplify deletion of an unnecessary log between one own device (GO) and two other devices (Clients).

The sets of log information in the communication device A, the communication device B and the communication device C are as follows.

Log of communication device A (own device)
Group 3 CL:E
Group 2 GO:D
Group 1 GO:B, C
   Log of communication device B (other device)
Group 4 CL:E
Group 1 CL:A
   Log of communication device C (other device)
Group 5 CL:F
Group 1 CL:A

Each of the communication device A, the communication device B and the communication device C has a log on a connection of Group 1 and all the devices store the log information of Group 1. As illustrated in FIG. 9A, the log information on Group 1 is deleted in the communication device B. The communication device A, the communication device B and the communication device C then enter the search phase. As illustrated in FIG. 9B, a probe_req and a probe_resp are communicated between the communication device A and the communication device B and the communication device B passes deletion check information to the communication device A. Based on the deletion check information, the communication device A recognizes that the communication device B does not store the log information of Group 1 and sets a flag that is exemplary addition of determination information indicating that there is not the log in the device address information of the communication device B contained in the log information on Group 1 in the own device. The device address information in which a flag is set will be marked with “” below.

Log of communication device A (own device)
Group 3 CL:E
Group 2 GO:D
Group 1 GO:“B”, C

Then, as illustrated in FIG. 9C, the log information on Group 1 is deleted in the communication device C. As illustrated in FIG. 9D, a probe_req and a probe_resp are communicated between the communication device A and the communication device C and the communication device C passes deletion check information to the communication device A. Based on the deletion check information, the communication device A recognizes that the log information on Group 1 is not stored in the communication device C and sets a flag representing that there is not the log in the device address information of the communication device C contained in the log information on Group 1 in the own device.

Log of communication device A (own device)
Group 3 CL:E
Group 2 GO:D
Group 1 GO:“B”, “C”

As illustrated in FIG. 9E, a flag representing that the log is not stored is set in all the members contained in the log information on Group 1 in the own device and thus the communication device A determines that the log information on Group 1 is unnecessary and deletes the log information on Group 1.

### Log Deletion Process Sequence according to First Embodiment

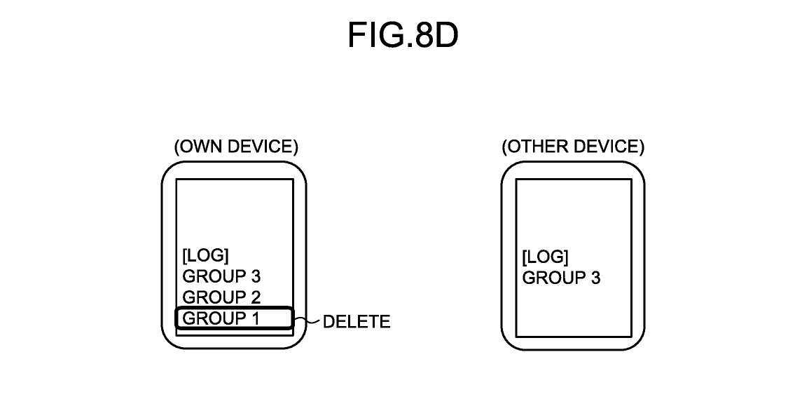

With reference to FIG. 10, a flow of a log deletion process performed between the communication devices 100 according to the first embodiment will be described. FIG. 10 is a sequence chart of an exemplary flow of a log deletion process performed between communication devices 100 according to the first embodiment. The communication device 100 represented in FIG. 10 and serving as an own device will be described as the communication device A and the communication device 100 represented in FIG. 10 and serving as an other device will be described as the communication device B.

As illustrated in FIG. 10, the communication device A transmits a probe_req to the communication device B (step S101). The communication device B having received the probe_req acquires the address of the communication device A that is the transmitter from the probe_req (step S102). The communication device B then acquires the log information in the communication device B (step S103). The communication device B then checks whether the address of the communication device A is in the acquired log information as a member. When the address of the communication device A is in the acquired log information as a member, the communication device B generates deletion check information containing the group ID in the log information and, when the address of the communication device A is not in the acquired log information, the communication device B generates deletion check information containing the group ID contained in the log information in the communication device B and the device address information of the communication device B (step S104).

The communication device B then sends, as a response, a probe_resp with the deletion check information added thereto to the communication device A (step S105). The communication device A having received the probe_resp acquires the log information in the communication device A (step S106). The communication device A then determines whether there is delible information in the log information in the communication device A (step S107). Specifically, the communication device A extracts log information containing, as a member, the address of the communication device B from which the probe_resp is transmitted and compares the extracted log information and the group ID contained in the deletion check information to determine whether unnecessary log information is contained. The communication device A then deletes the unnecessary log information (step S108).

### Flow of Log Deletion Determining Process According to First Embodiment

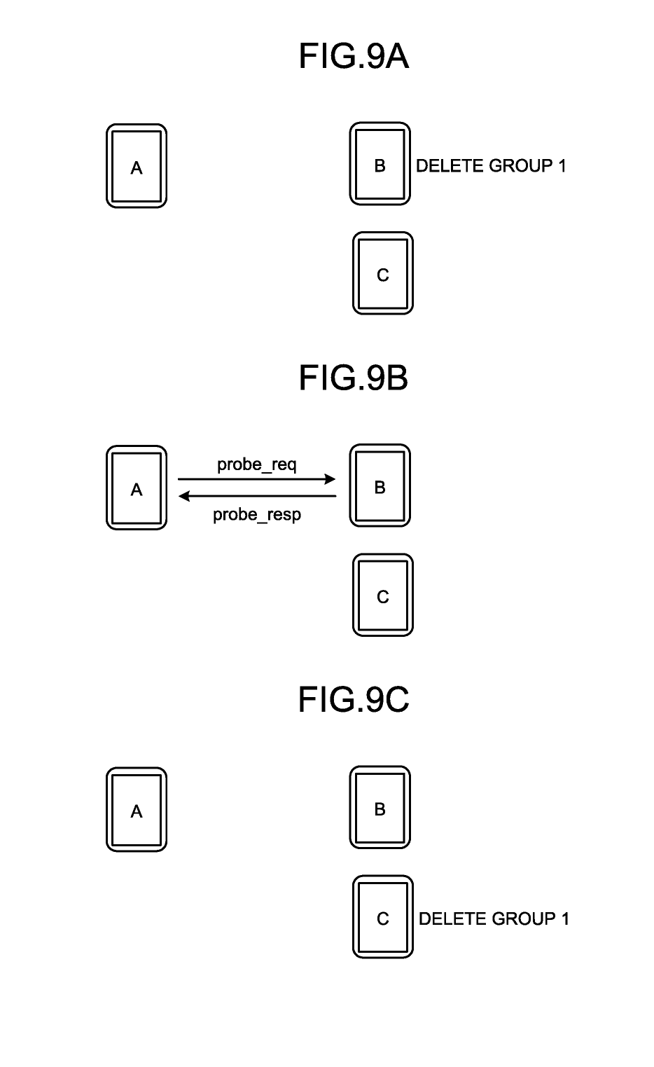

The flow of the log deletion determining process according to the first embodiment will be described with reference to FIG. 11. FIG. 11 is a flowchart of an exemplary flow of the log deletion determining process according to the first embodiment.

As illustrated in FIG. 11, the communication device 100 extracts, from the log information in the own device, information containing the device address information of the transmitter that is acquired from the probe_resp (step S201). The communication device 100 compares the extracted log information and the group ID acquired from the probe_resp to determine whether there is a combination of the group ID and the device address information in the log information (step S202). When the combination of the group ID and the device address information is not in the log information (NO at step S202), the communication device 100 sets a flag in the device address information in the log information stored only in the own device (step S203). On the other hand, when the combination of the group ID and the device address information is in the log information (YES at step S202), the communication device 100 ends the process without deleting the log information.

The communication device 100 then determines whether a flag is set in every set of device address information in the group (step S204). When a flag is set in every set of device address information in the group (YES at step S204), the communication device 100 deletes the corresponding log information (step S205). On the other hand, when a flag is not set in every set of device address information (NO at step S204), the communication device 100 ends the process without deleting the log information.

### Effect of First Embodiment

On transmission and reception of search packets in the search phase in which a connectable other device is searched for, the communication device 100 acquires the group ID stored in the other device and the device address information of the other device and, when a combination of the group ID and the device address information is not contained in the log information in the own device, deletes the log information stored only in the own device. As a result, the communication device 100 is able to manage the log information efficiently. In other words, the communication device 100 deletes the log information in the own device that is not synchronized with the log information stored in another communication device 100 and thus is able to manage the log information efficiently. The communication device 100 communicates information for checking synchronization of the sets of log information by using the search packets and thus is able to manage the log information efficiently without using any new packet or communications for synchronization.

### SECOND EMBODIMENT

The first embodiment exemplifies the case where the log information is deleted in the search phase in which the search packets are communicated between the devices. A second embodiment exemplifies the case where unnecessary log information is deleted when new log information is registered. The hardware configuration of a communication device 100a according to the second embodiment is the same as that of the communication device 100 according to the first embodiment. Functions of the communication device 100a different from those according to the first embodiment will be described below.

### Functional Configuration of Communication Device According to Second Embodiment

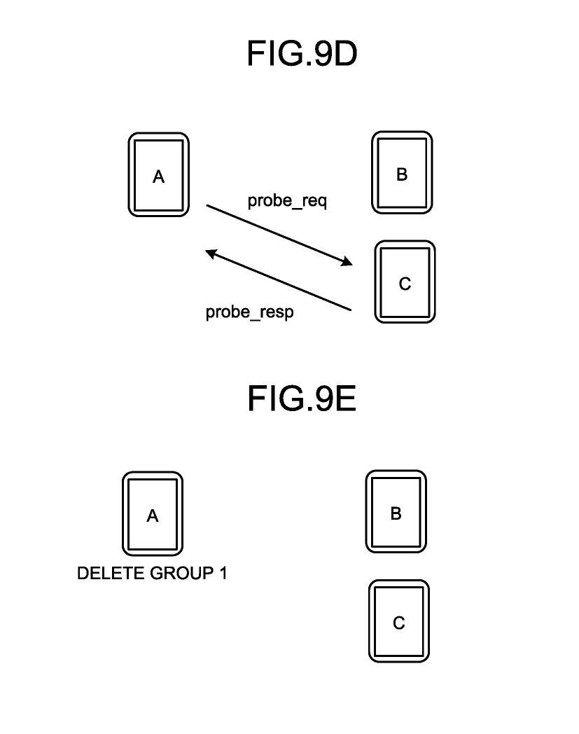

With reference to FIG. 12, the functional configuration of the communication device 100a according to the second embodiment will be described. FIG. 12 is a block diagram of an exemplary functional configuration of the communication device 100a according to the second embodiment. In the second embodiment, the same functions as those of the communication device 100 according to the first embodiment are denoted with the same reference numbers as those of the first embodiment, and descriptions thereof may be omitted. Specifically, the communication controller 110 and the acquisition unit 120 are the same functions as those of the communication device 100 according to the first embodiment.

As illustrated in FIG. 12, a communication device 100a includes the communication controller 110, the acquisition unit 120, a determining unit 130a, a log deletion unit 140a and a log register 150a. All or part of these components may be implemented by using software (a program) or a hardware circuit.

The log register 150a registers log information. More specifically, when a connection is established between at least two of the communication devices 100a and accordingly a group is formed, the log register 150a registers information on the formed group as log information.

When new log information is registered, the determining unit 130a determines whether there are sets of log information on groups between which the same members are contained. More specifically, when the log register 150a registers new log information, the determining unit 130a determines whether there are new log information and already-registered information on groups between which the same members are contained. In other words, the determining unit 130a determines whether there are sets of information on groups having different group IDs but between which the contained members are the same in the log information in the own device.

When it is determined that there are sets of log information between which the same members are contained, the log deletion unit 140a deletes the log information that was registered much before among the sets of log information. More specifically, when the determining unit 130a determines that there are sets of log information having different IDs but between which the same members are contained, the log deletion unit 140a deletes the log information that is registered much before among the sets of log information on the corresponding groups. In other words, with respect to the sets of log information on the groups only having different group IDs but between which the members are the same, it is possible to make a connection by using any one of the sets of log information and thus the log deletion unit 140a deletes any one of the sets of log information as unnecessary log information. Here, an older set of log information is deleted.

An example where an unnecessary log is deleted on registration of new log information will be described below.

### Log of own device

Group 2 GO:B (new log information)

Group 1 GO:B

Assume that log information on Group 1 is already registered in the own device. In this state, when log information on Group 2 is registered additionally, Group 1 and Group 2 have different IDs but the member is the same between the groups (the member is the communication device B in both the groups) and thus the communication device 100a deletes the log information on Group 1 that was registered much before. Even when the log information on Group 1 is deleted, the communication device B is able to reconnect to the own device by using the log information on Group 2. The log information on Group 1 in the own device is deleted and accordingly the log information on Group 1 is deleted also in the communication device B through the process according to the first embodiment. The log information on Group 2 might have been generated as the log information on Group 1 was deleted in the communication device B. In any case, unnecessary logs are deleted in both the communication devices.

### Log of Own Device

Group 2 GO:B, C (new log information)
Group 1 GO:B, C

Assume that log information on Group 1 is already registered in the own device. In this state, when log information on Group 2 is registered additionally, Group 1 and Group 2 have different IDs but the members are the same between the groups and thus the communication device 100a deletes the log information on Group 1 that was registered much before. In the case where there are at least two members in a group, even when one of the members is connected, the members are not the same and thus the log information is not to be omitted. Specifically, when the communication device B in Group 2 is connected but the communication device C is not connected, the log information on Group 1 is not deleted; however, at the time when the communication device C is connected additionally after the connection of the communication device B, the log information on Group 1 is to be deleted.

### Flow of Log Deletion Determining Process According to Second Embodiment

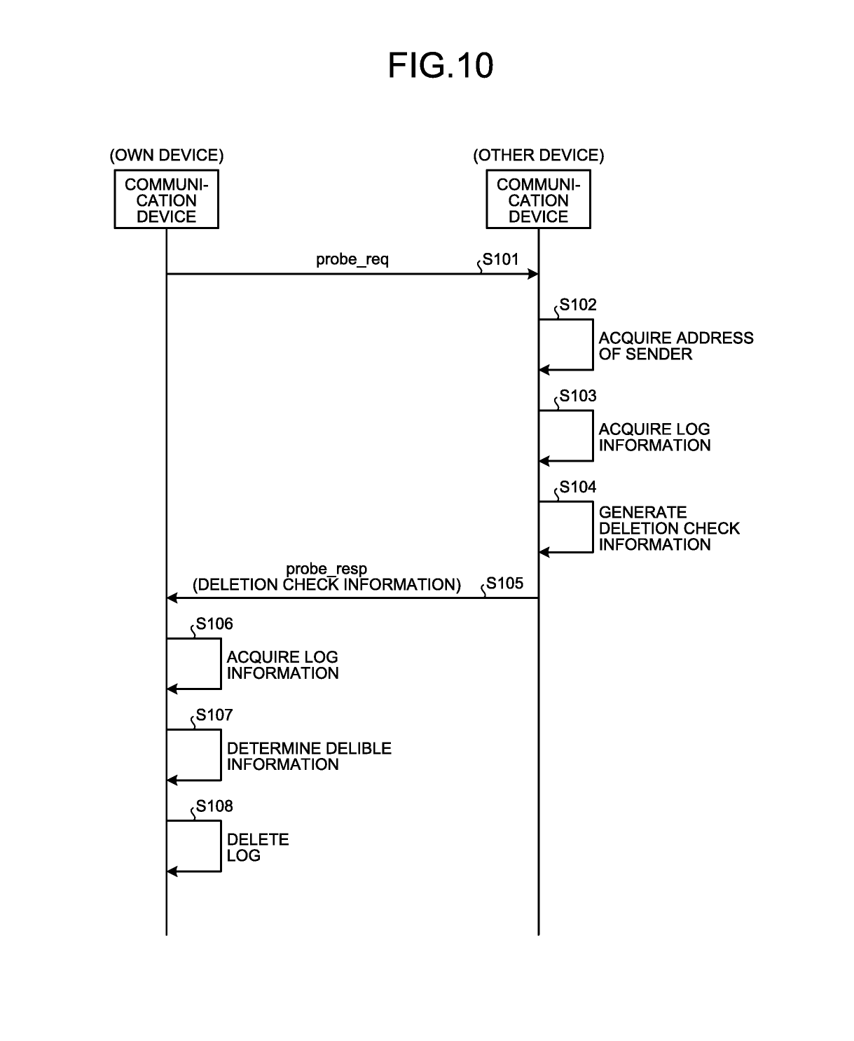

With reference to FIG. 13, a flow of a log deletion determining process according to the second embodiment will be described. FIG. 13 is a flowchart of an exemplary flow of the log deletion determining process according to the second embodiment.

As illustrated in FIG. 13, when a connection is established between at least two of the communication devices 100a including the own device and a group is formed, the communication device 100a registers information on the formed group as new log information (step S301). The communication device 100a determines whether there are already-registered log information and additionally-registered log information on different groups between which the same members are contained (step S302). When there are sets of log information between which the same members are contained (YES at step S302), the communication device 100a deletes, among the sets of log information on the different groups, the log information on the group that was registered much before (step S303). On the other hand, when there are not sets of log information between which the sane members are contained (NO at step S302), the communication device 100a does not delete any log information and ends the process.

### Effect of Second Embodiment

On registration of new log information, when there are the same members between the groups, the communication device 100a deletes the log information on the group among the corresponding groups that was registered much before and thus is able to manage the log information efficiently.

### THIRD EMBODIMENT

The first embodiment exemplifies the case where the log information is deleted in the search phase in which the search packets are communicated between the terminals. A third embodiment exemplifies a case where, when the number of storable sets of log information reaches an upper limit, log information on a group having a smaller number of members is deleted will be described. The hardware configuration of a communication device 100b according to the third embodiment is the same as the hardware configuration of the communication device 100 according to the first embodiment. Functions of the communication device 100b different from those of the first embodiment will be described below.

### Functional Configuration of Communication Device According to Third Embodiment

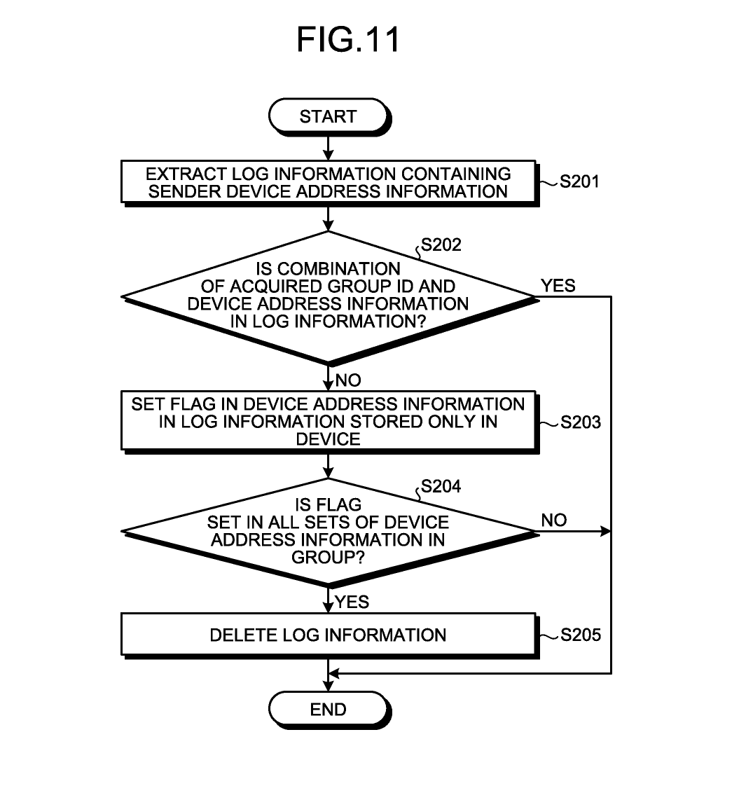

With reference to FIG. 14, a functional configuration of a communication device 100b according to a third embodiment will be described. FIG. 14 is a block diagram of an exemplary functional configuration of the communication device 100b according to the third embodiment. In the third embodiment, the same functions as those of the communication device 100 according to the first embodiment are denoted with the same reference numbers as those of the first embodiment, and descriptions thereof may be omitted. Specifically, the communication controller 110, the acquisition unit 120 and the determining unit 130 are the same functions as those of the communication device 100 according to the first embodiment.

As illustrated in FIG. 14, the communication device 100b includes the communication controller 110, the acquisition unit 120, the determining unit 130, a log deletion unit 140b, a log register 150b, and a number-of-members calculator 160b. All or part of those components may be implemented by using software (a program) or a hardware circuit.

The log register 150b registers log information. More specifically, when a connection is established between at least two of the communication devices 100b and accordingly a group is formed, the log register 150b registers information on the formed group as log information.

When the number of sets of log information storable in the own device reaches an upper limit, the number-of-members calculator 160b calculates the number of members of each group. More specifically, when the number of sets of log information storable in the own device reaches an upper limit because of registration of new log information by the log register 150b, the number-of-members calculator 160b calculates the number of members of each group, i.e., the number of members that are communication devices 100b serving as other devices contained in each group. While the number of members is 1 when the own device is a Client, the number of members is at least 1 when the own device is a GO.

The log deletion unit 140b deletes log information on a group having a smaller number of members. More specifically, the log deletion unit 140b deletes log information on a group having a smaller number of members that is calculated by the number-of-members calculator 160b. In other words, the log deletion unit 140b deletes log information on a group having a smaller number of members such that the number of communication devices 100b that are connectable other devices increases.

An example where, when the number of sets of log information reaches the upper limit, the log on a group having a smaller number of members is deleted will be described below. In order to simplify the description, 3 is set for the upper limit of the number of sets of log information.

Log of own device
Group 4 GO:H, I (new log information)
Group 3 GO:G
Group 2 GO:D, E, F
Group 1 GO:B, C

Assume that sets of log information on Group 1, Group 2 and Group 3 are already registered in the own device. In this state, when log information on Group 4 is registered additionally, the number of sets of log information exceeds 3 that is the upper limit. The communication device 100b calculates the number of members of each of the groups. For example, the number of members of Group 1 is “2”, the number of members of Group 2 is “3”, and the number of members of Group 3 is “1”. Among the groups, a group having a smaller number of members is Group 3 (the number of members is “1”). Thus, the communication device 100b deletes the log information on Group 3 and registers Group 4 as new log information. Accordingly, the communication device 100b is able to minimize the number of communication devices 100b that are other devices with which it is not possible to make a log connection.

### Flow of Log Deletion Determining Process According to Third Embodiment

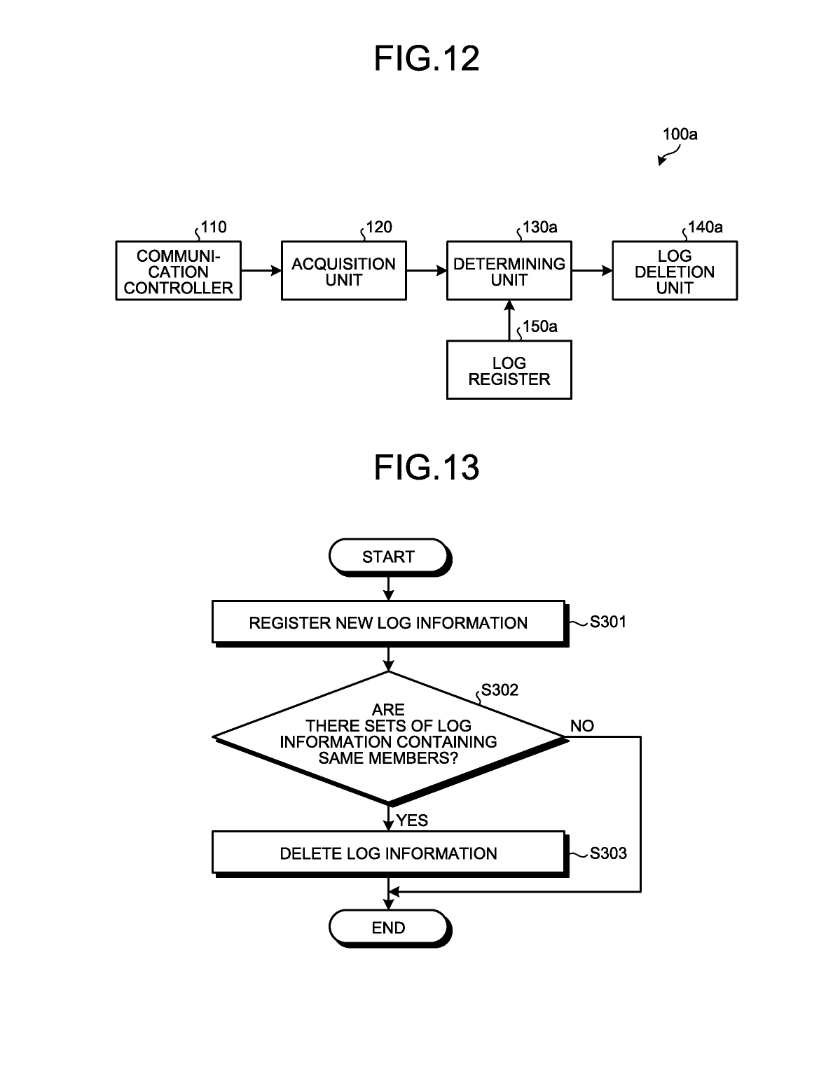

With reference to FIG. 15, a flow of a log deletion determining process according to the third embodiment will be described. FIG. 15 is a flowchart of an exemplary flow of the log deletion determining process according to the third embodiment.

As illustrated in FIG. 15, when a connection is established between at least two of the communication devices 100b including the own device and a group is formed, the communication device 100b registers information on the formed group as new log information (step S401). The communication device 100b determines whether the number of sets of log information reaches the upper limit because of the registration of the new log information (step S402). When the number of sets of log information reaches the upper limit (YES at step S402), the communication device 100b calculates the number of members contained in each of the groups (step S403). On the other hand, when the number of sets of log information does not reach the upper limit (NO at step S402), the communication device 100b does not delete any set of log information and ends the process. The communication device 100b then deletes log information on a group where the calculated number of members is smaller (step S404).

### Effect of Third Embodiment

When the number of sets of storable log information reaches the upper limit, the communication device 100b calculates the number of members contained in each group and deletes the log information on a group where the calculated number of members is smaller and accordingly is able to manage the log information efficiently.

### FOURTH EMBODIMENT

The first embodiment exemplifies the case where the log information is deleted in the search phase in which the search packets are communicated between the devices. A fourth embodiment exemplifies the case where log information on a group with a smaller number of connections is deleted. The hardware configuration of the communication device 100c according to the fourth embodiment is the same as that of the communication device 100 according to the first embodiment. Functions of the communication device 100c different from those according to the first embodiment will be described below.

### Functional Configuration of Communication Device According to Fourth Embodiment

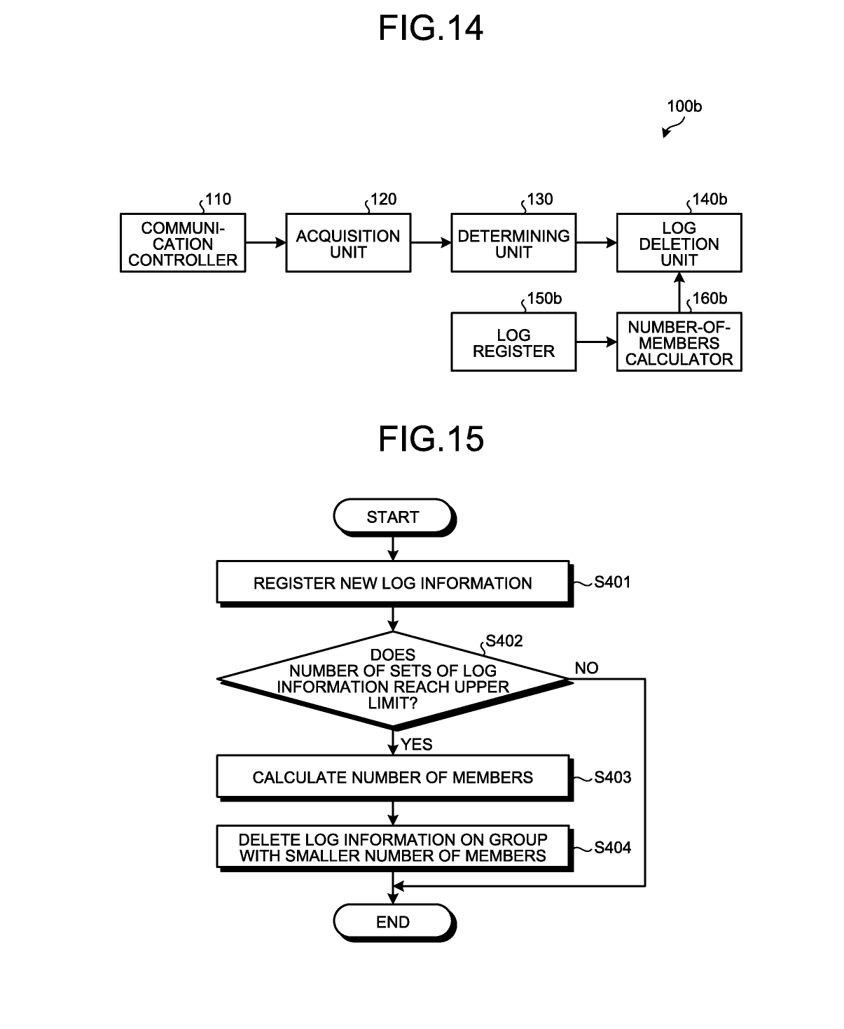

With reference to FIG. 16, the functional configuration of the communication device 100c according to the fourth embodiment will be described. FIG. 16 is a block diagram of an exemplary functional configuration of the communication device 100c according to the fourth embodiment. In the fourth embodiment, the same functions as those of the communication device 100 according to the same embodiment are denoted with the same reference numbers as those of the first embodiment, and descriptions thereof may be omitted. Specifically, the communication controller 110, the acquisition unit 120 and the determining unit 130 are the same functions as those of the communication device 100 according to the first embodiment.

As illustrated in FIG. 16, the communication device 100c includes the communication controller 110, the acquisition unit 120, the determining unit 130, a log deletion unit 140c, a number-of-connections counter 170c, and a number-of-connections calculator 180c. All or part of those components may be implemented by using software (a program) or a hardware circuit.

The number-of-connections counter 170c counts the number of connections that are made by each of the members of a group. More specifically, after a connection is established between the communication devices 100c according to the control of the communication controller 110 and a group is formed, the number-of-connections counter 170c counts (increments) the number of connections made by each member of the group each time reconnection is made by using the log information.

The number-of-connections calculator 180c calculates the sum of the numbers of connections of each group. More specifically, the number-of-connections calculator 180c calculates the sum of the numbers of connections of each group that are counted by the number-of-connections counter 170c. The process performed by the number-of-connections calculator 180c may be performed at any timing, for example, at regular intervals of time, in response to a user operation when, for example, new log information is registered or when the upper limit of the number of sets of log information is reached due to registration of new log information.

The log deletion unit 140c deletes the log information on a group where the sum of the numbers of connections of the group is smaller. More specifically, the log deletion unit 140c deletes the log information on a group where the sum of the numbers of connections of the group is smaller that is calculated by the number-of-connections calculator 180c. In other words, the log deletion unit 140c regards log information on a group where the number of connections is smaller as log information less important and deletes the log information.

Descriptions will be given for an example where the log information on a group where the sum of the numbers of connections is smaller is deleted. The case where the deletion is performed when new log information is registered will be exemplified. The numbers each between brackets represents the counted number of connections.

Log of own device
Group 4 GO:H, I (new log information)
Group 3 GO:G (10)
Group 2 GO:D (1), E (1), F (1)
Group 1 GO:B (3), C (2)

It can be seen that, in the log information on Group 1, the own device serves as a GO and the communication device B and the communication device C are contained as members (clients). Furthermore, by using the log information on Group 1, the communication device B has made three log connections and the communication device C has made two log connections. According to the log information on Group 2, the own device servers as a GO and a communication device D, a communication device E and a communication device F are contained as members. By using the log information on Group 2, each of the communication device D, the communication device E, and the communication device F have made the a log connection. According to the log information on Group 3, the own device servers as a GO and a communication device G is contained as a member. By using the log information on Group 3, the communication device G has made ten log connections.

From the sum of the numbers of connections made by the respective members of each group, specifically, from “Group 1: 3+2=5”, “Group 2: 1+1+1=3” and “Group 3: 10”, the communication device 100c deletes the log information on Group 2 where the sum is smaller. As described above, when the number of log connections is small even when the number of members in a group is large, the log information is considered as one less frequently used (less important) and thus is deleted.

A member registered across groups is able to make a log connection by using any one of the sets of log information. For this reason, the log deletion unit 140c may calculate the sum of the numbers of connections of each group after excluding a smaller number of connections among the numbers of connections made by a member registered across groups. Descriptions will be given for an example where the sum of the numbers of connections is calculated with respect to each group after excluding a smaller number of connections among the numbers of connections made by a member registered across groups.

Log of own device
Group 4 GO:H, I (new log information)
Group 3 GO:F (8)
Group 2 GO:D (1), E (1), C (4)
Group 1 GO:B (5), C (2)

By using the log information on Group 1, the communication device B has made five log connections and the communication device C has made two log connections. By using the log information on Group 2, the communication device D has made a log connection, the communication device E has made a log connection, and the communication device C has made four log connections. By using the log information on Group 3, the communication device F has made eight log connections. The communication device C is a member that is registered across Group 1 and Group 2. Regarding the communication device C, the smaller number of connections in Group 1 is excluded.

From the sum of the numbers of connections made by the respective members of each group, specifically, from “Group 1: 5 (excluding the number of connections made by the communication device C)”, “Group 2: 1+1+4=6” and “Group 3: 8”, the communication device 100c deletes the log information on Group 1 where the sum is smaller.

When the number of connections is the same between the communication device C of Group 1 and the communication device C of Group 2, the number of older connections may be excluded. Specifically, when the numbers of connections made by a member that is registered across groups are the same, the log deletion unit 140c excludes the number of older connections and calculates the sum of the numbers of connections with respect to each group.

Information representing the degree of intention to be an access point is set in a device in which Wi-Fi Direct is installed. The information is referred to as a GOlntent. A GOlntent is a value that is set as a fixed value in a device in which Wi-Fi Direct is installed and that represents the degree of intention to be an access point. The value of a GOIntent is represented by a number from the numbers 0 to 15. The larger the number of the GOIntent is, the higher the degree of intention to be a GO is and, the smaller the number of the GOIntent is, the higher the degree of intention to be a Client is. The designer of the device sets a GOIntent in consideration of the performance of the device and the way in which the device is used. In a process of Group Owner Negotiation, devices exchange the values of GOIntent and the device with a higher value serves as a GO.

In the log information, information on whether the own device is a GO or a Client is recorded. In consideration of the information on whether the own device is a GO or a Client, the number of connections is weighted according to the value of the GOIntent. Specifically, when the GOIntent is high, the device intends to be a GO and thus the log where the device serves as a GO is valued. When the GOIntent is low, the device intends to be a Client and thus the log where the device serves as a Client is valued.

Specifically, based on the information of the GOIntent indicating the degree of intention of the own device to serve as an access point and make a connection, the number-of-connections calculator 180c weights the sum of the numbers of connections. The log deletion unit 140c deletes the log information on a group where the weighted sum of the numbers of connections of the group is smaller. An example where the log information on a group where the sum of the numbers of connections that is weighted in consideration of the GOIntent is smaller is deleted will be described.

Log of own device
Group 4 GO:E (new log information)
Group 3 GO:D (4)
Group 2 Client:C (3)
Group 1 GO:B (6)

When the GOIntent is “1”, the degree of intention to be a Client is the maximum and thus the sum of the numbers of connections of the log where the device was a Clinet is multiplied by N to increase the importance of the log information. Any number may be set for N. For example, when N=2, the number-of-connections calculator 180c weights the sum of the numbers of connections of the members of each group and calculates “Group 1: 6”, “Group 2: 3×2=6” and “Group 3: 4”. Accordingly, the log deletion unit 140c deletes the log information on Group 3 where the sum is smaller.

When the GOIntnet is “14”, the degree of intention to be a GO is higher and thus the importance of the log information is increase by multiplying the sum of the numbers of connections in the log where the device served as a GO. When the GOIntent is a value from “2 to 6”, the degree of intention to be a Client is not as high as the case of the GOIntent “1”. In that case, when there are multiple logs where the sums are the smallest, the Client is valued and the sum is weighted. When the GOIntent is a value from “9 to 13”, the degree of intention to be a GO is not as high as the case of the GOIntent “14”. In that case, when there are multiple logs where the sums are the smallest, the GO is valued and the sum is weighted. When the GOIntent is “7” or “8”, the degree of intention to be a GOIntent is at a middle and the device does not intend to be any of a GO and a Client. In this case, it is unnecessary to perform weighting depending on whether the device intends to be a GO or a Client.

### Flow of Log Deletion Determining Process According to Fourth Embodiment

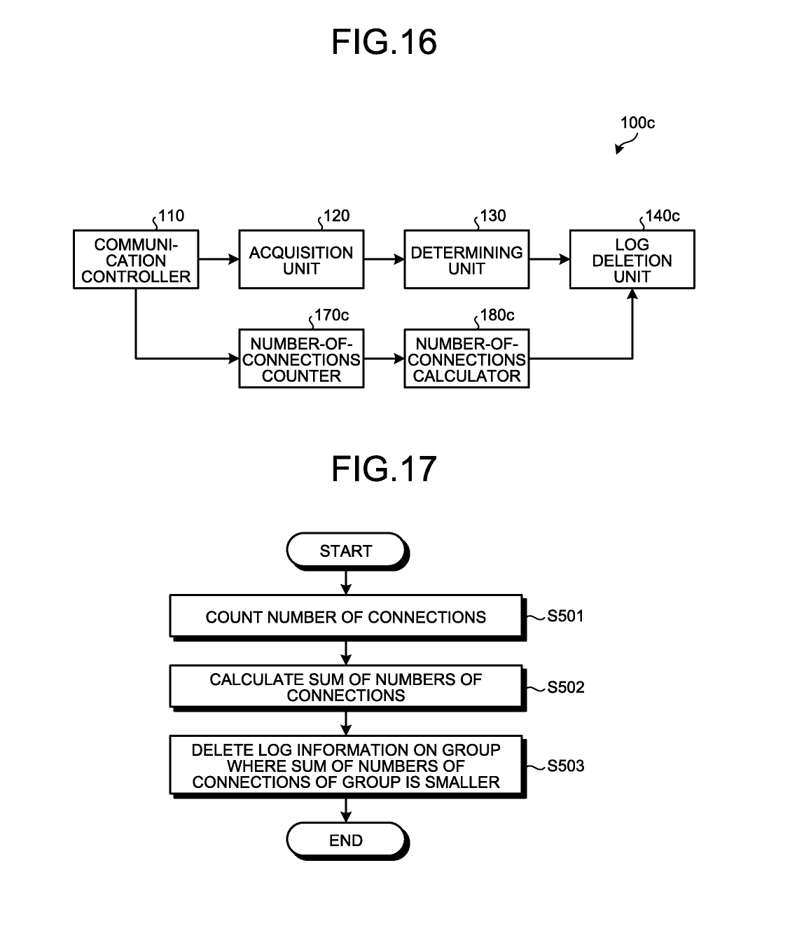

With reference to FIG. 17, a flow of a log deletion determining process according to the fourth embodiment will be described. FIG. 17 is a flowchart of an exemplary flow of the log deletion determining process according to the fourth embodiment.

As illustrated in FIG. 17, when a reconnection using the log information is made, the communication device 100c counts the number of connections of each member in a group (step S501). The communication device 100c then calculates a sum of the numbers of connections of each group (step S502). The communication device 100c then deletes log information on a group where the sum of the numbers of connections of the group is smaller (step S503).

### Effect of Fourth Embodiment

The communication device 100c counts the number of connections using the log, calculates the sum of the numbers of connections of each group from the numbers of connections made by the members of each group, and deletes the log information on a group where the sum is smaller, which makes it possible to manage the log information efficiently. When the same member is registered across multiple groups, after excluding a smaller number of connections from the numbers of connections made by the member, the communication device 100c calculates the sum of the numbers of connections of each group and deletes the log information on a group where the sum is smaller, which makes it possible to efficiently manage the log information. The communication device 100c weights the sum of the numbers of connections on the basis of the information indicating the degree of intention of the own device to serve as an access point and deletes the log information on a group where the weighted sum is smaller, which makes it possible to efficiently manage the log information.

### FIFTH EMBODIMENT

The embodiments of the communication device 100 according to the invention have been described above. The invention may be carried out in various different modes in addition to the above-described embodiments. Different embodiments of (1) the configuration and (2) the program will be described.

### (1) Configuration

The process procedure, the control procedure, the specific names, the various types of data, and the information including parameters that are described above or represented in the drawings may be changed unless otherwise noted. Each of the components of the device illustrated in the drawings are of functional ideas and are not necessarily required to be configured physically as illustrated in the drawings. In other words, specific modes of dispersion and integration of the device are not limited to those illustrated in the drawings and they may be partly or entirely dispersed or integrated functionally or physically according to any unit and according to the various types of loads or the use of the device.

### (2) Program

In a mode, a log information management program executed by the communication device 100 is recorded in a file in an installable or executable form in a computer-readable recording medium, such as a CD-ROM, a flexible disk (FD), a CD-R, or a digital versatile disk (DVD), and is provided. The log information management program that is executed by the communication device 100 may be stored in a computer that is connected to a network, such as the Internet, and may be downloaded via the network to be provided. The log information management program that is executed by the communication device 100 may be configured to be provided or distributed via a network, such as the Internet. The log information management program that is executed by the communication device 100 may be configured to be incorporated in, for example, a ROM in advance to be provided.

The log information management program that is executed by the communication device 100 has a module configuration containing each of the above-described components (the acquisition unit 120, the determining unit 130 and the log deletion unit 140). Regarding practical hardware, the CPU reads the log information management program and executes the program and accordingly the components are loaded into the main storage device and the acquisition unit 120, the determining unit 130 and the log deletion unit 140 are generated on the main storage device.

According to a mode of the invention, there is an effect that it is possible to manage the log information efficiently.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A communication device comprising:
circuitry configured to
acquire, from other device, deletion check information for checking whether log information in an own device containing a log on connections with other devices contains delible information;
determine whether the log information in the own device contains delible information based on the acquired deletion check information; and
delete, when it is determined that delible information is contained in the log information in the own device, corresponding information from the log information in the own device.

2. The communication device according to claim 1, wherein
the circuitry is further configured to
control communications with other devices, and
acquire, on transmission and reception of search messages for searching for a connectable peer, the deletion check information.

3. The communication device according to claim 1, wherein
the log information contains group identifying information for identifying a group consisting of at least two communication devices between which a connection is established and device address information representing an address of other device contained in the group,
the circuitry acquires, from the other device, the deletion check information containing the group identifying information stored in the other device and the device address information of the other device,
the circuitry determines whether a combination of the acquired group identifying information stored in the other device and the acquired device address information of the other device is contained in the log information in the own device, and
when it is determined that the combination of the group identifying information stored in the other device and the device address information of the other device is not contained in the log information in the own device, the circuitry deletes information on a group that is stored only in the own device from the log information in the own device.

4. The communication device according to claim 3, wherein
when it is determined that the combination of the group identifying information stored in the other device and the device address information of the other device is not contained in the log information in the own device, the circuitry adds determination information to the device address information of the other device contained in the information on the group stored only in the own device and, when determination information is added to all sets of device address information of other devices contained in the information on the group, deletes the information on the group stored only in the own device from the log information in the own device.

5. The communication device according to claim 1, wherein
the circuitry is further configured to
register the log information,
determine, when new log information is registered, whether there are sets of log information on groups, each consisting of at least two communication devices between which a connection is established, between which the same members are contained, and
delete, when it is determined that there are sets of log information between which the same members are contained, log information registered much before among the sets of log information between which the same members are contained.

6. The communication device according to claim 1, wherein
the circuitry is further configured to
register the log information;
calculate, when the number of sets of log information storable in the own device reaches an upper limit because of registration of new log information, the number of members of each group consisting of at least two communication devices between which a connection is established, and
delete log information on a group where the calculated number of members is smaller.

7. The communication device according to claim 1, wherein
the circuitry is further configured to
count the number of connections made by each member in a group consisting of at least two communication devices between which a connection is established;
calculate a sum of the numbers of connections of each group from the numbers of connections of the respective members of the group, and
delete the log information on a group where the sum of the numbers of connections of the group is smaller.

8. The communication device according to claim 7, wherein
the circuitry calculates the sum of the numbers of connections of each group after excluding a smaller number of connections among the numbers of connections made by a member registered across groups.

9. The communication device according to claim 7, wherein,
when the numbers of connections made by a member registered across groups are the same, the circuitry excludes the number of connections made by the member registered much before and then calculates the sum of the numbers of connections of each group.

10. The communication device according to claim 7, wherein
the circuitry weights the sum of the numbers of connections based on information representing the degree of intention of the own device to serve as an access point and make a connection, and
the circuitry deletes the log information on a group where the weighted sum of the numbers of connections of the group is smaller.

11. A log information management method executed by a communication device, the method comprising:
acquiring, from other device, deletion check information for checking whether log information in an own device containing a log on connections with other devices contains delible information;
determining whether the log information in the own device contains delible information based on the acquired deletion check information; and
when it is determined that delible information is contained in the log information in the own device, deleting corresponding information from the log information in the own device.

12. A non-transitory computer-readable recording medium that contains a log information management program that causes a communication device to execute a process comprising:
acquiring, from other device, deletion check information for checking whether log information in an own device containing a log on connections with other devices contains delible information;
determining whether the log information in the own device contains delible information based on the acquired deletion check information; and
when it is determined that delible information is contained in the log information in the own device, deleting corresponding information from the log information in the own device.
